(19) United States
(12) Patent Application Publication
(10) Pub. No.: US 2012/0078602 A1
(43) Pub. Date: Mar. 29, 2012

(54) METHOD FOR PREDICTING ANEURYSM GROWTH

(76) Inventors: Marcus Pfister, Bubenreuth (DE); Thomas Redel, Poxdorf (DE)

(21) Appl. No.: 13/246,111

(22) Filed: Sep. 27, 2011

(30) Foreign Application Priority Data
Sep. 29, 2010 (DE) 102010041626.6

(51) Int. Cl. G06G 7/60

(52) U.S. Cl. 703/11

(57) ABSTRACT

A method for predicting aneurysm growth based on CFD simulations derived from at least two angiography recordings is proposed. A first 3-D recording of the aneurysm is recorded at a first time and a first vascular geometry is determined for simulating a first CFD simulation. A second 3-D recording is recorded at a second time and a second vascular geometry is determined for simulating a second CFD simulation. The two 3-D recordings are registered and a local growth rate is determined from the two 3-D recordings. The local growth rate is correlated between the two vascular geometries with hemodynamically derived parameters from the first CFD simulation. A future vascular geometry and/or a future local growth rate is predicted based on the correlation parameters, the hemodynamic parameters from the second CFD simulation and the second vascular geometry.

### CROSS REFERENCE TO RELATED APPLICATIONS

This application claims priority of German application No. 10 2010 041 626.6 filed Sep. 29, 2010, which is incorporated by reference herein in its entirety.

### FIELD OF THE INVENTION

The invention relates to a method for predicting aneurysm growth based on CFD simulations derived from at least two angiography recordings.

### BACKGROUND OF THE INVENTION

The present patent application deals with the prediction of further aneurysm growth by introducing hemodynamic parameters, e.g. simulated flow in the aneurysm and shear forces occurring as a result. In the literature such hemodynamic parameters are considered to be important growth mediators, as set out by Barry J. Doyle et al. in “A comparison of modelling techniques for computing wall stress in abdominal aortic aneurysms” [1].

A hemodynamic parameter refers in particular to a parameter affecting a hemodynamic, i.e. a flow mechanism of the blood. In order to conclude such hemodynamic parameters, the blood flow for example is simulated in a vessel segment that contains the aneurysm.

Dilatations of the abdominal aorta below the outlet of the renal arteries to more than 3 cm are referred to as abdominal aortic aneurysms (AAA). The number of patients treated in Germans hospitals for an unruptured abdominal aortic aneurysm (AAA) in 2002 totaled 11,697; since then it has risen slightly to 12,531 cases in 2007. The proportion of women is around 15%. The number of patients with ruptured AAAs has risen similarly from 1,899 in 2000 to 2,350 in 2007. In the case of an arterial aneurysm the artery is dilated to 1.5 times its size. Since the infrarenal aortic diameter is usually around 2 cm, in epidemiological examinations an abdominal aortic aneurysm has been defined above a diameter of 3.0 cm. However it must be taken into account that the aortic diameter increases with age and is larger in men than women. In general clinical terms then a diameter of 3 to 4 cm is therefore also frequently referred to as an aneurysmatic dilatation of the infrarenal aorta or an abdominal aortectasis.

The average increase in the size of the AAA is 2 to 3 mm/year. It is more for smokers but can fluctuate considerably from individual to individual. The risk of rupture of an AAA<4 cm is below 2% per year but increases exponentially from a diameter of >5 cm. Risk factors for the threat of rupture apart from the maximum diameter are a rapid increase in diameter (>0.5-1 cm/year), a family history, an eccentric morphology and continued nicotine abuse, as described by Hans-Henning Eckstein et al. in “Ultraschall-Screening abdominaler Aortenaneurysmen” (Ultrasonic screening for abdominal aortic aneurysms) [2].

The problem after diagnosis of an AAA is the decision whether to treat the aneurysm, in other words whether to subject the patient to an open OP or endovascular therapy, or whether the aneurysm should simply be observed, generally by means of a regular CT scan. An essential parameter for this decision is how quickly the AAA is likely to develop in other words the growth rate predicted for the AAA.

However the problem is that in addition to the growth-induced effect of the hemodynamic parameters, patient-specific parameters such as genetics, pre-existing conditions or behavior play an important role.

A CFD simulation is currently used in numerous examinations to calculate hemodynamic variables, such as wall shear stress (WSS) or pressure in an AAA, in order then to be able to draw conclusions about the further growth of an AAA. This is set out for example in Barry J. Doyle et al., “A comparison of modelling techniques for computing wall stress in abdominal aortic aneurysms”, David S. Molony et al., “Fluid-structure interaction of a patient-specific abdominal aortic aneurysm treated with an endovascular stent-graft”, or James H Leung et al., “Fluid structure interaction of patient specific abdominal aortic aneurysms: a comparison with solid stress models” [1,3,4].

“Computational Fluid Dynamics”, abbreviated to CFD, is a method for simulating the blood flow in a vessel segment of a blood vessel containing a pathological alteration. Such a pathological alteration of the vessel segment is present for example in the form of an aneurysm, i.e. a pathological, locally limited, frequently ballooning dilatation. An aneurysm can occur in particular in a blood vessel in the region of the brain or heart; however the occurrence of an aneurysm is generally not limited to a specific body region. The clinical significance of an aneurysm, located for example in the brain, relates in particular to the risk of rupture, in other words the formation of a tear or break, which can produce bleeding and thrombosis for example. In medicine today the dynamic behavior of the blood flow in an aneurysm is frequently seen as an important factor for the pathogenesis of the aneurysm, in other words its formation and development.

It is also known that growth can be determined by comparing a number of successive examinations of the AAA, for example using computed tomography.

In “A computational framework for fluid-solid-growth modeling in cardiovascular simulations” by C. Alberto Figueroa et al. [5] and in “Computed Wall Stress May Predict the Growth of Abdominal Aortic Aneurysm” by Zhi-Yong Li [6] the mechanical stress on the internal structure of the aorta is examined and used as a basis for analyses.

In [5] a very comprehensive framework is presented for calculating local growth based on hemodynamic forces by means of an algorithmic description of biological properties of the vessel wall. The central point however is that only reasonable assumptions are or can be made. Generally the information is of interest for patients in whom the vessel wall has altered or no longer corresponds to assumptions for pathological reasons.

In [6] page 2629, second paragraph, it states:

“Future work is needed in the assessment of the mechanical properties of AAA components. There are two major determinants for AAA rupture: wall stress and wall strength. An AAA ruptures only when the local stress exceeds the local wall strength. However, lack of AAA material strength data made it impossible to predict local strength value for comparison with local stress value.”

It is therefore indicated specifically that such a correlation founders due to the lack of availability of corresponding parameters. The reasonable assumptions required for [5] cannot be derived, i.e. calculated, in practice.

US 2009/0043187 A1 describes a method for determining a rupture risk of at least one aneurysm in a patient, the rupture risk being determined on the part of a computation facility as a function of at least one personal factor specific to the patient and at least one anatomy-related factor affecting the anatomy of and/or in the region of the at least one aneurysm and at least one simulation-related factor determined on the basis of at least one simulation performed by means of the and/or a further computation facility and based on anatomical data for the at least one aneurysm.

### SUMMARY OF THE INVENTION

The invention is based on the object of making a prognosis about the growth of AAAs, how the aneurysm will develop, with patient-specific influencing variables or suboptimal selection of basic conditions for the CFD simulation being eliminated or at least reduced.

According to the invention the object is achieved by the features set out in the independent claim. Advantageous developments are set out in the dependent claims.

According to the invention the object is achieved by the following steps:
S1) First 3-D recording of the aneurysm and determination of a first vascular geometry at a first time,
S2) First CFD simulation based on this first vascular geometry,
S3) Second 3-D recording of the aneurysm and determination of a second vascular geometry at a second, later time,
S4) Registering of the two 3-D recordings,
S5) Determination of the local growth rate from the two 3-D recordings,
S6) Correlation of the local growth rates between the two vascular geometries with hemodynamically derived parameters from the first CFD simulation and storage of the correlation results,
S7) Second CFD simulation based on the second vascular geometry and/or on the first CFD simulation,
S8) Prediction of the vascular geometry and/or local growth rate at a future time based on the correlation parameters, the hemodynamic parameters from the second CFD simulation in step S7) and the vascular geometry at the second time.

Correlating CFD simulations and vessel measurements allows more reliable prediction of aneurysm growth without the adverse effects of patient-specific influencing variables or basic conditions for the CFD simulation.

The essential core of the present patent application is that the known procedure includes a patient-specific, local growth property in an unknown clinical context. It is therefore also possible with for example unknown genetic or clinical information to correlate growth and external factors. Evaluation of the extrapolated growth predictions is a task for medical experts.

The core of the present patent application is also to ignore the internal structure used as the basis of the analyses according to [5] and [6] and instead to measure and correlate the response of the vessel wall as a whole to external influences (mechanically and hemodynamically). Our correlation captured by measuring technology here is simpler but can be measured individually for each patient. The essential point is the measurement. This model is therefore replaced by a black box, in which the response of the vessel wall is not described in detail but the resulting growth correlations are set out in the form of the measurement values.

The 3-D recordings according to step S1) and step S3) can advantageously be produced using at least one imaging method from the group

Computed tomography (CT),

Magnetic resonance tomography (MRI),

Ultrasound (US) and/or

Angiography (DynaCT).

According to the invention the correlation results according to step S6) can indicate which of the simulated hemodynamic parameters have actually contributed to the growth (between T1 and T2) or which of the simulated hemodynamic parameters has contributed significantly to the growth of the aneurysm, how the individual parameters have contributed to the growth of the aneurysm and/or the correlation coefficients.

According to the invention the registering of the two 3-D images according to step S4) can take place in a rigid or flexible manner.

It has proven advantageous to use the lumen and/or thrombus to determine the vascular geometry according to step S1) and step S3).

According to the invention the local growth rate is determined from the increase in the local radius divided by the time between the two 3-D recordings.

The second 3-D recording at the second time (T2) according to step S3) can advantageously take place around three months after the first 3-D recording at the first time (T1) according to step S1).

It has proven advantageous for the hemodynamically derived parameters according to step S6) and/or step S8) to be at least one parameter from the group:

A simulated flow in an aneurysm,

Shear forces occurring due to the blood flow,

A pressure in an aneurysm,

A stress affecting the vessel wall,

A shear stress affecting the vessel wall and

A flow rate

### BRIEF DESCRIPTION OF THE DRAWINGS

The invention is described in more detail below based on exemplary embodiments illustrated in the drawing, in which:

FIG. 1 shows a known x-ray system with an industrial robot as support apparatus for a C-arm,

FIG. 2 shows a vessel segment based on an angiography recording, and

FIG. 3 shows the inventive method.

### DETAILED DESCRIPTION OF THE INVENTION

Various imaging systems, such as computed tomography (CT), magnetic resonance tomography (MRI), ultrasound (US) and/or rotational angiography systems (DynaCT), can be used to produce 3-D recordings of an aneurysm for example.

To perform such a rotational angiography to produce 3-D images in order to obtain a 3-D vessel segment model of an AAA for example, x-ray systems are used, the typical key features of which can be for example at least one C-arm, which can be robot-controlled and to which an x-ray tube and x-ray image detector are attached, a patient support table, a high-voltage generator for generating the tube voltage, a system control unit and an imaging system including at least one monitor.

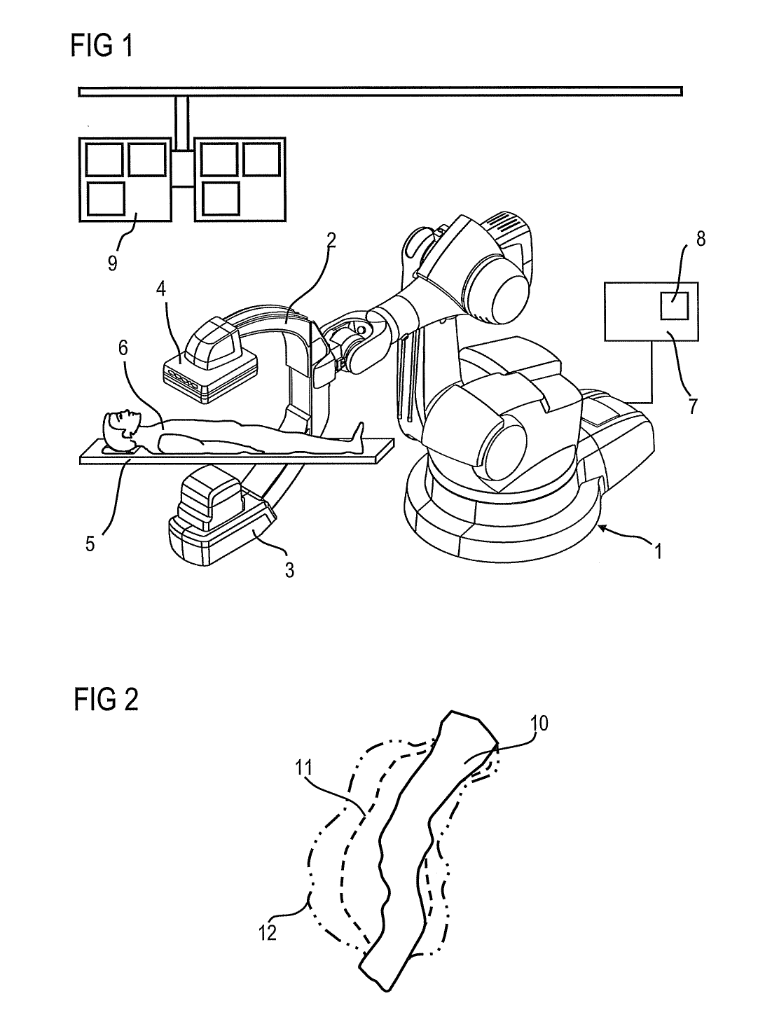

Such a typical x-ray system shown by way of example in FIG. 1 with robot-mounted C-arm for example features for example a C-arm 2 supported in a rotatable manner on a mount in the form of a six-axis industrial or articulated arm robot 1, at the ends of which an x-ray radiation source, for example an x-ray emitter 3 having an x-ray tube and collimator, and an x-ray image detector 4 are positioned as the image recording unit.

Generally CTA and MRA are also suitable for producing the 3-D models. The advantage of C-arm systems is that the 2-D recordings can optionally be intrinsically registered. Otherwise this has to be done with all modalities.

The articulated min robot 1 known for example from U.S. Pat. No. 7,500,784 B2, which preferably has six axes of rotation and therefore six degrees of freedom, can be used to displace the C-arm 2 in any manner spatially, for example by rotating it about a center of rotation between the x-ray emitter 3 and the x-ray image detector 4. The inventive x-ray system 1 to 4 can in particular be rotated about centers of rotation and axes of rotation in the C-aim plane of the x-ray image detector 4, preferably about axes of rotation intersecting the center point of the x-ray image detector 4 and about the center point of the x-ray image detector 4.

The known articulated arm robot 1 features a base frame, which is permanently mounted for example on a base. A turntable is fastened thereto in such a manner that it can be rotated about a first axis of rotation. A robot swing is positioned on the turntable in such a manner that it can be pivoted about a second axis of rotation with a robot arm fastened thereto in such a manner that it can be pivoted about a third axis of rotation. A robot hand is positioned at the end of the robot aim in such a manner that it can be rotated about a fourth axis of rotation. The robot hand features a fastening element for the C-arm 2, which can be pivoted about a fifth axis of rotation and can be rotated about a sixth axis of rotation perpendicular thereto.

The implementation of the x-ray diagnostic facility is not dependent on the industrial robot. Conventional C-arm devices can also be used.

The x-ray image detector 4 can be a rectangular or square, flat semiconductor detector, which is preferably made of amorphous silicon (a-Si). However integrating and optionally also counting CMOS detectors can also be used.

A patient 6 to be examined is positioned as the examination object in the beam path of the x-ray emitter 3 on a patient support table 5 for the purpose of recording the heart for example. Connected to the x-ray diagnostic facility is a system control unit 7 having an image system 8, which receives and processes the image signals from the x-ray image detector 4 (operating elements are not shown for example). The x-ray images can then be viewed on display units in a monitor bank 9.

FIG. 2 shows a vessel segment 10, as shown in a 3-D recording of a basic examination at time T1. In an examination performed at a later time T2 than the time T1—for example the present time—the vessel wall 11 shows an AAA in a current 3-D recording.

The main problem with predicting the growth of AAAs is the question of how the aneurysm will develop up to a future time T3, when the geometries of the aorta at times T1 and T2 are known.

The aim is now, based on a patient-specific prediction, to reproduce the pattern of the future vessel wall 12 with an AAA as precisely as possible.

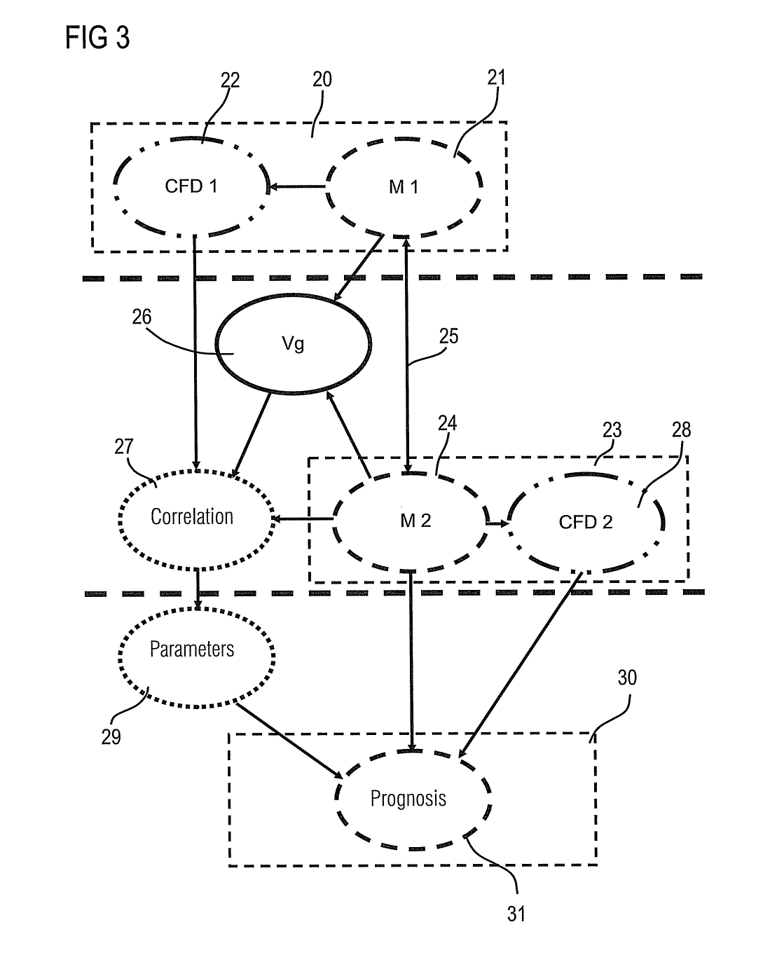

This is achieved by the method shown symbolically in FIG. 3. First for example a DynaCT recording or CT recording must be available at a first examination time T1 as the first 3-D recording 20 or so-called baseline 3-D recording, on the basis of which a first vessel measurement 21 can be performed. This vascular geometry of the vessel segment 10 obtained from the first vessel measurement 21 can be used to perform a first CFD simulation 22.

At a second examination time T2, for example the present, a current second 3-D recording 23 is produced again for example using a DynaCT system or a CT system, allowing a second vessel measurement 24 to determine a second vascular geometry. Registering 25 of the two 3-D recordings 20 and 23 and therefore also of the two vascular geometries of the vessel measurements 21 and 24 then takes place.

This data 20, 21, 23 and 24 is then used to determine the local growth rates 26 (Vg) for each vessel segment of the vascular geometry between the first examination time T1 and the second examination time T2.

Correlation 27 of the local growth rate Vg takes place between the two vascular geometries 21 and 24 with hemodynamically derived parameters from the first CFD simulation 22 and the correlation results are stored.

A second CFD simulation 28 is performed based on the current 3-D recording 23 at the second examination time T2 with the second vessel measurement 24.

It is possible to calculate from the correlation 27 and the second CFD simulation 28 which of the simulated hemodynamic parameters 29 has actually contributed to the growth of the AAA between the examination times T1 and T2. This information then allows the growth to be used more reliably for a prediction 30 of future growth of the AAA at a future examination time T3, so that a prognosis 31 can be made regarding a third vascular geometry. This prognosis 31 can be used to assess further measures, for example whether the aneurysm should be treated, in other words whether to subject the patient to an open OP or endovascular therapy, or whether the aneurysm should simply be observed.

A 3-D recording with a further vessel measurement can then be produced at a third examination time, for example in three months. Once the 3-D recordings have been registered, the local growth rates Vg for each vessel segment of the vascular geometries is determined between the examination times and correlated with hemodynamically derived parameters from CFD simulations for a new prediction of future growth of the AAA.

The simulated hemodynamic parameters 29 can for example be:

A simulated blood flow in an aneurysm,

Shear forces occurring due to the blood flow,

A pressure in an aneurysm,

A stress affecting the vessel wall,

A shear stress affecting the vessel wall and

A flow rate

The intermediate steps of the growth rates Vg for each vessel segment of the vascular geometries between the examination times can be interpolated, in order optionally to be able to produce a continuous growth profile later. This allows virtual intermediate models to be produced and used for CFD simulations, thereby allowing iterative monitoring or adjustment.

The idea underlying the inventive method for predicting aneurysm growth is therefore to calculate, from the known measurements and simulations at times T1 and T2 (present) by correlation, which of the simulated parameters have actually contributed to the growth (between T1 and T2). This information makes it possible then to predict the growth at time T3 more reliably.

The inventive method sequence can be summarized as follows:

In a first step S1) a first 3-D recording 20 is taken of the aneurysm and a first vascular geometry is determined at a first time T1.

This is followed according to a second step S2) by a first CFD simulation 22 based on this first vascular geometry.

In a third step S3) a second 3-D recording 23 is taken of the aneurysm and a determination 24 is performed of a second vascular geometry at a second, later time T2.

According to a fourth step S4) the two 3-D recordings 20 and 23 are registered with one another (25).

In a fifth step S5) a determination 26 of the local growth rate takes place from the two 3-D recordings 20 and 23.

Then according to a sixth step S6) a correlation 27 is performed of the local growth rate between the two vascular geometries with hemodynamically derived parameters from the first CFD simulation 22 and storage of the correlation results takes place.

In a seventh step S7) a second CFD simulation 28 takes place based on the second vascular geometry and/or on the first CFD simulation 22.

Then in an eighth step S8) a prediction 30 is made of the vascular geometry and/or the local growth rate at a future time (T3) based on the correlation parameters 29, the hemodynamic parameters from the second CFD simulation 28 in step S7) and the vascular geometry 24 at the second time (T2).

The inventive method provides a simple way of combining personal factors with the results of the hemodynamic simulations and an improved basis for predicting the further growth of an aneurysm.

To this end according to the invention it is proposed that the growth of an AAA should be recorded using at least two successive 3-D imaging methods and the derived growth rate should be correlated with hemodynamically derived variables (e.g. WSS) from a CFD simulation, the result being applied to a second CFD simulation.

Requirements for the proposed method are:
At least two recordings of the aorta have been produced at two different times T1 and T2, from which it is possible to determine or measure the local AAA growth.
These two recordings are registered with one another, it being possible for this to be done in a rigid or flexible manner.
A CFD simulation of the aorta is available for the recording at time T1.

Optional:
The intermediate growth steps can be interpolated, in order optionally to be able to produce a continuous growth profile later. This allows virtual intermediate models to be produced and used for CFD simulations, thereby allowing iterative monitoring or adjustment.

Correlation of the measurements and simulations:
The CFD simulation at time T1 is now correlated with the (actually measured) AAA growth between times T1 and T2. This allows the following to be determined:
   Which of the simulated hemodynamic parameters has contributed significantly to the growth of the aneurysm.
   How the individual parameters have contributed to the growth of the aneurysm.
   The correlation coefficient.

Prediction of aneurysm growth:
If a CFD simulation of the aorta recording at time T2 is now produced, it, along with the previously determined correlation parameters and the vascular geometry at time T2, can be used for a more reliable growth prediction.

Example of a workflow:
1. First 3-D recording (CT, MRI, US, DynaCT) of the AAA and determination of the vascular geometry (lumen, thrombus),
2. CFD simulation based on this geometry,
3. Second 3-D recording of the AAA and determination of the vascular geometry (lumen, thrombus) e.g. after 3 months,
4. Registering (rigid or flexible) of the two 3-D recordings,
5. Determination of the local growth rate (e.g. increase in the local radius divided by the time between the two 3-D recordings),
6. Correlation of the local growth rate with the results from the CFD simulation of the first geometry. These are stored,
7. CFD simulation based on the second geometry,
8. Prediction of the future vascular geometry and/or the future local growth rate based on the correlation parameters, the hemodynamic parameters from the second CFD simulation in step S7 and the vascular geometry at the second time.

Specifically a correlation is proposed between

a) one (or more) simulated hemodynamic parameters in a defined simulation setting with
b) the individual aneurysm growth (actually measured between two or more scans) to see how these parameters impact on further growth.

The proposed solution can in principle be used for all aneurysm types, in other words also for thoracic aortic aneurysms or intracranial aneurysms for example. However for the sake of simplicity the description only relates to AAAs.

Patient-specific influencing variables such as genetics or suboptimal selection of basic conditions for the CFD simulation are eliminated by the inventive method. The prediction can be verified with new 3-D imaging in the case of aneurysms under observation.

### LITERATURE

[1] Barry J. Doyle, Anthony Callanan and Timothy M. McGloughlin; A comparison of modelling techniques for computing wall stress in abdominal aortic aneurysms; BioMedical Engineering OnLine 2007, 6:38; pages 1 to 12
[2] Hans-Henning Eckstein, Dittmar Böckler, Ingo Flessenkämper, Thomas Schmitz-Rixen, Sebastian Debus, Werner Lang; Ultraschall-Screening abdominaler Aortenaneurysmen (Ultrasonic screening for abdominal aortic aneurysms); Deutsches Ärzteblatt, Jg. 106, vol. 41, Oct. 9, 2009, pages 657 to 663
[3] David S. Molony, Anthony Callanan, Eamon G. Kavanagh, Michael T. Walsh and Tim M. McGloughlin; Fluid-structure interaction of a patient-specific abdominal aortic aneurysm treated with an endovascular stent-graft; BioMedical Engineering OnLine 2009, 8:24; pages 1 to 12
[4] James H Leung, Andrew R Wright, Nick Cheshire, Jeremy Crane, Simon A Thom, Alun D Hughes and Yun Xu; Fluid structure interaction of patient specific abdominal aortic aneurysms: a comparison with solid stress models; BioMedical Engineering OnLine 2006, 5:33, pages 1 to 15
[5] C. Alberto Figueroa, Seungik Baek, Charles A. Taylor, Jay D. Humphrey A computational framework for fluid-solid-growth modeling in cardiovascular simulations Comput. Methods Appl. Mech. Engrg. 198, pages 3583 to 3602
[6] Zhi-Yong Li Computed Wall Stress May Predict the Growth of Abdominal Aortic Aneurysm 32nd Annual International Conference of the IEEE EMBS, Buenos Aires, Argentina, Aug. 31-Sep. 4, 2010, pages 2626 to 2629

1.-9. (canceled)

10. A method for predicting growth of an aneurysm based on CFD simulations derived from at least two angiography recordings, comprising:
recording a first 3-D recording of the aneurysm and determining a first vascular geometry at a first time;
simulating a first CFD simulation based on the first vascular geometry;
recording a second 3-D recording of the aneurysm and determining a second vascular geometry at a second time;
registering the first and the second 3-D recordings;
determining a local growth rate from the first and the second 3-D recordings;
correlating the local growth rate between the first and the second vascular geometries with hemodynamic parameters derived from the first CFD simulation and storing the correlation result;
simulating a second CFD simulation based on the second vascular geometry; and
predicting a future vascular geometry and/or a future local growth rate based on the correlation result, hemodynamic parameters derived from the second CFD simulation, and the second vascular geometry.

11. The method as claimed in claim 10, wherein the first and the second 3-D recordings are recorded using an imaging method selected from the group consisting of: Computed tomography, Magnetic resonance tomography, Ultrasound, and Angiography.

12. The method as claimed in claim 10, wherein the correlation result indicates which of the hemodynamic parameters derived from the first CFD simulation has actually contributed to the local growth rate between the first time and the second time.

13. The method as claimed in claim 10, wherein the correlation result indicates which of and how the hemodynamic parameters derived from the first CFD simulation has significantly contributed to the local growth rate and/or correlation coefficients.

14. The method as claimed in claim 10, wherein the first and the second 3-D recordings are registered rigidly or flexibly.

15. The method as claimed in claim 10, wherein the first and the second vascular geometries are determined by a lumen and/or thrombus.

16. The method as claimed in claim 10, wherein the local growth rate is deter mined from an increase in a local radius divided by time between the first and the second 3-D recordings.

17. The method as claimed in claim 10, wherein the second 3-D recording is recorded around three months after the first 3-D recording.

18. The method as claimed in claim 10, wherein the hemodynamic parameters derived from the first or the second CFD simulation comprises a parameter selected from the group consisting: a simulated blood flow in the aneurysm, shear forces occurring due to the blood flow, speed of the blood flow, pressure in the aneurysm, stress affecting a vessel wall, shear stress affecting the vessel wall, and a flow rate of the blood flow.

19. The method as claimed in claim 10, wherein the second CFD simulation is simulated based on the second vascular geometry and/or the first CFD simulation.
